(19) United States
(12) Patent Application Publication
(10) Pub. No.: US 2010/0237060 A1
(43) Pub. Date: Sep. 23, 2010

(54) METHOD AND SYSTEM FOR CONTROLLING A HEATING ELEMENT WITH TEMPERATURE SENSITIVE CONDUCTIVE LAYER

(75) Inventor: Lenny Novikov, Cliffside Park, NJ (US)

Correspondence Address: LUCAS & MERCANTI, LLP, 475 PARK AVENUE SOUTH, 15TH FLOOR, NEW YORK, NY, 10016, US

(73) Assignee: Weiss Controls, Inc., Holtsville, NY (US)

(21) Appl. No.: 12/727,544

(22) Filed: Mar. 19, 2010

Related U.S. Application Data
(60) Provisional application No. 61/210,499, filed on Mar. 19, 2009.

(51) Int. Cl. H05B 3/02

(52) U.S. Cl. 219/488; 219/490

(57) ABSTRACT

Methods and system for controlling a heater conductor in a heating element including a sensor conductor separated from the heater conductor by an NTC layer. The heating element is coupled to a control circuit and the flow of electricity from a direct current source through the circuit is controlled such that a change of the resistance of the NTC layer is indicative of the temperature of the heater conductor. This resistance is detected based on a time or amplitude analysis and based thereon, a heating mode of the heater conductor is controlled. In a variation, the circuit is operated in a two-period measurement mode wherein the energy transferred through the NTC layer in one period is equal and opposite to the energy transferred through the NTC layer in the other period.

### CROSS-REFERENCE TO RELATED APPLICATION

This application claims priority under 35 USC 119 of U.S. Provisional Patent Application Ser. No. 61/210,499 filed Mar. 19, 2009, the entire disclosure of which is incorporated by reference herein.

### FIELD OF THE INVENTION

The present invention relates generally to a method and system for controlling a heater conductor (for example a wire) of a heating element including a negative temperature coefficient (NTC) layer and more specifically to a method and system for controlling a flexible heater conductor having a conductive core with an NTC layer and a helically wound sensor conductor within an insulative outer sheath.

### BACKGROUND INFORMATION

Modern heating pads and electronic blankets have heater wires (conductors) that do not require separate thermostats. They fall into two basic types: a heater wire having a positive temperature coefficient (PTC) heating layer arranged between two conductors that exhibits an increased resistance with an increase in temperature so that the wire is self-limiting and not subject to hot spots; and a heater wire that provides a feedback signal to a control for monitoring temperature and detecting local hot spots.

A prior art system that uses a feedback signal for temperature control concurrently with a voltage, that also indicates the occurrence of a hot spot that deteriorates the insulation between a heater conductor and a sensor or sensor wire, is described in U.S. Pat. No. 5,861,610. A PTC nickel alloy sensor wire is counter-wound around a heater wire with an inner insulation therebetween. Current leakage through the insulation electrically couples the sensor wire and the heater wire. Resistance of the sensor wire is measured and used for temperature control. An alternating current (AC) voltage present on the sensor wire indicates the existence of a breakdown in the separating insulation. When polyvinylchloride (PVC) is used as the separating layer, small leakage occurs at about 160° C. When polyethylene is used as the separating layer, the layer melts at about 130° C. and contact is made between the heater wire and the sensor wire. In both cases, i.e., when leakage occurs or contact between the heater wire and the sensor wire is made, the control unit disconnects power to the heater wire.

A similar technique is disclosed in U.S. Pat. No. 6,310,332 (Gerrard), the entire disclosure of which is incorporated herein by reference, wherein a second conductor is used as a heater with the insulation having an enhanced Negative Temperature Coefficient (NTC) characteristic. The two heating conductors are connected through a diode so that leakage through the NTC layer introduces the negative half cycle, which presence causes termination of the power. In a second embodiment, the second conductor is a PTC sensor wire, such as disclosed in U.S. Pat. No. 5,861,610, the entire disclosure of which is incorporated herein by reference.

A smaller more flexible heater wire design is disclosed in U.S. Pat. No. 6,222,162 (Keane), the entire disclosure of which is incorporated herein by reference, and uses a single conductor of a PTC alloy for both heating and temperature sensing. In this device, only the average temperature is used to control the temperature of the wire.

To address these concerns, a heater wire is disclosed in U.S. Pat. No. 7,180,037 (Weiss), the entire disclosure of which is incorporated herein by reference, which is operated with an alternating current power supply. The heater wire has a conductive core with an NTC layer and a helically wound sensor conductor within an insulative outer sheath. The conductive core is coupled to a control circuit, with a phase shift relative to the AC power supply being indicative of the temperature of the wire.

### OBJECTS AND SUMMARY OF THE INVENTION

An object of the present invention is to provide a method and system for controlling a direct current-operated heating element comprising a heating conductor and a sensor conductor separated by an NTC layer that decreases its resistance with increasing temperature. The parallel arrangement of the NTC layer enhances the detection of local hot spots anywhere along the surface of the heating element.

The heater wire described in U.S. Pat. No. 7,180,037 (Weiss), incorporated in its entirety by reference herein, where the heater wire is operated with an alternating current power supply, may be used as an example of a heating element for present invention. A direct DC application of this type of heating element is unreliable because the NTC conductive layer is subject to polarization and aging under DC conditions, therefore it is imperative to measure resistance of the NTC layer without polarizing any portion of it.

While the following description of the methods and systems refers to the construction of that particular heating element, comprising a heater wire, a sense or sensor wire, and an NTC layer between them, it is understood that the proposed technology is valid for any types of heating elements employing the NTC layer as a temperature sensing component, whether constructed with wires or any other conductor types.

It is yet another object of the present invention to provide a method and system to measure resistance of the NTC layer without polarizing it.

In the proposed solution, the heating element is coupled to a control circuit and the flow of electricity from a direct current (DC) source through the circuit is controlled such that a change of the resistance of the NTC layer is indicative of the temperature of the heater wire. This resistance is detected based on a time or amplitude analysis and based thereon, a heating mode of the heating element is controlled. For example, when the heating element is above a threshold temperature, the heating mode is not initiated.

The methods and systems described herein operate the heating element by periodically interrupting the heating mode, when the heating element is powered from a DC source, with the measurement mode, when the NTC layer resistance is measured. Based on this evaluation the following heating mode cycle is skipped and/or replaced with a non-heating interval to achieve temperature regulation of the heating element.

In a variation of the method and system, the measurement cycle is performed with only alternating current (AC) passing through the NTC layer while the NTC layer resistance is measured based on a time or amplitude analysis and based thereon, a heating mode of the heater wire is controlled.

In another variation of the method and system, the circuit is operated in a two-period measurement mode wherein the energy transferred through the NTC layer in one period is equal and opposite to the energy transferred through the NTC layer in the other period. In the first period of the measurement mode, DC current from a DC source is directed through the NTC layer in a first direction and based thereon, a heating mode of the heater wire is controlled. In the second period of the measurement mode, which may immediately follow the first period, the DC power current from the DC source is directed through the NTC layer in a second direction, opposite to the first one, and the time of flow of the DC power current in the second direction is controlled to provide an equal energy transfer through the NTC layer during the two periods of the measurement mode. The time may be controlled based on a time in which DC current flowed through the NTC layer in the first measurement period, and amplitudes of the current through the NTC layer in the first and second measurement periods such that a product of the amplitude and time for the first measurement period equals the product of the amplitude and time for the second measurement period. This equal energy transfer technique may be implemented using a capacitor that is charged in the first period and discharged in the second period, or controlled to ensure that the current through the NTC layer in the second period is of the same magnitude as the current through the NTC layer in the first period but opposite in direction, e.g., via switches.

Control of the heater wire is particularly suitable for use with DC (Direct Current) operated appliances such as heating pads and electric blankets.

### BRIEF DESCRIPTION OF THE DRAWINGS

The invention may best be understood by reference to the following detailed description of illustrative embodiments when read in conjunction with the accompanying drawings, wherein:

FIG. 1A is a schematic of a first embodiment of a system for controlling a heater wire of a heating element using an AC excitation technique;

FIG. 1B is a schematic of a second embodiment of a system for controlling a heater wire of a heating element using an AC excitation technique;

FIG. 2A is a schematic of a first embodiment of a system for controlling a heater wire of a heating element using an equal energy transfer technique;

FIG. 2B is a schematic of a second embodiment of a system for controlling a heater wire of a heating element using an equal energy transfer technique;

FIG. 3 shows an implementation of the system shown in FIG. 2A;

FIG. 4 is a signal diagram of the circuit shown in FIG. 3;

FIG. 5 shows an enhanced implementation of a variation of the system shown in FIG. 2A; and

FIG. 6 shows an implementation of the system shown in FIG. 1B.

### DETAILED DESCRIPTION

The description of the preferred embodiments given below is intended for illustration and not for limitation purposes, and it is understood that those skilled in art can find different implementations of this invention without departing from the scope and spirit of the invention. It is further understood that the illustrative drawings and corresponding descriptions use labels such as “SENSE WIRE” and “HEATER WIRE” for illustration purposes only, and Rntc represents a distributed resistance property of the NTC layer. To simplify the discussion, it is assumed that the NTC layer resistance is significantly higher than the resistance of the heater wire or sense wire, and the effect of the actual heater or sense wires resistance on the results of the NTC layer resistance measurements is diminishingly small and may be neglected.

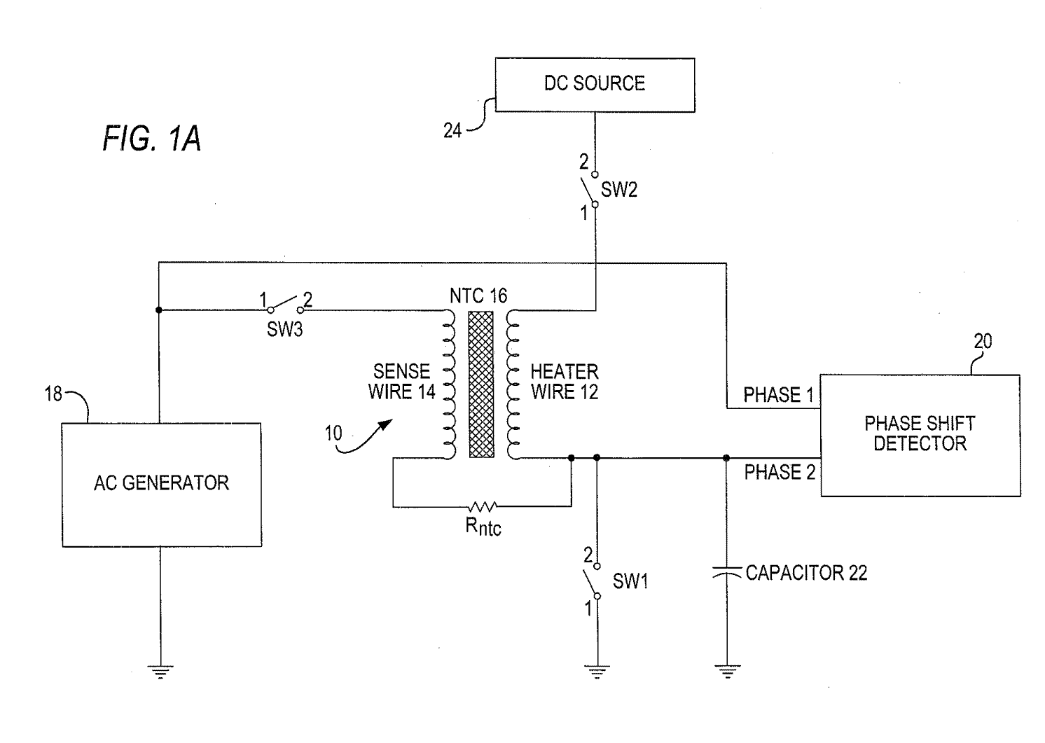

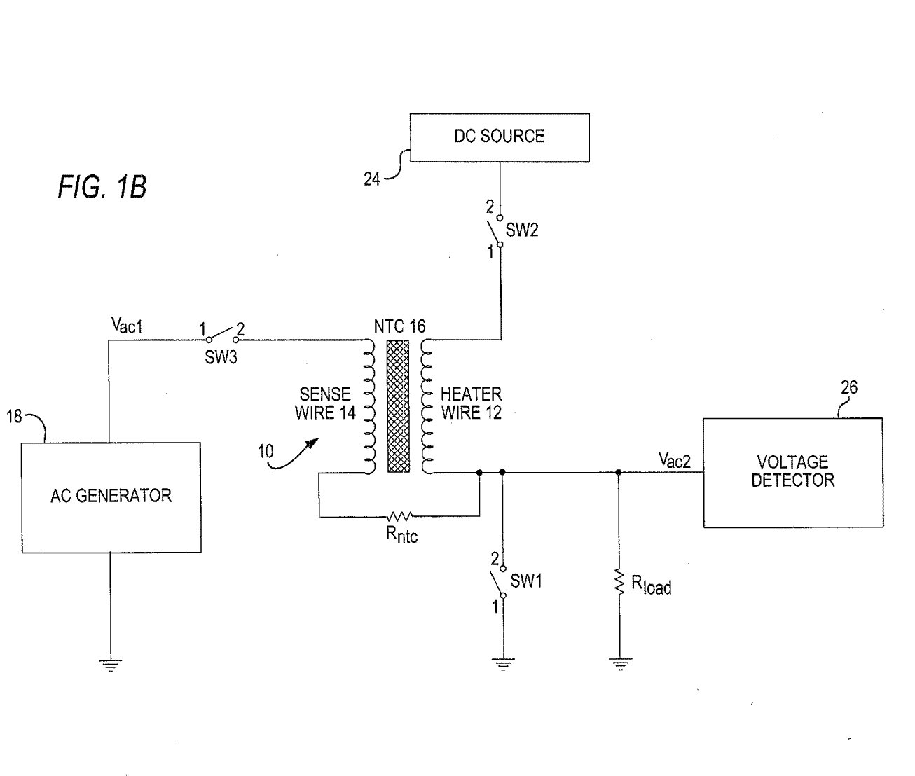

Referring to the accompanying drawings wherein like reference numbers refer to the same or similar elements, FIG. 1A illustrates a first embodiment of the invention wherein an alternating current (AC) excitation method uses direct current (DC) to power a heater wire and an AC generator to measure the resistance of a negative temperature coefficient (NTC) layer.

In this embodiment, a system for controlling a heater wire in accordance with the invention includes a heating element 10 that comprises the heater wire 12, a sensor wire 14, and an NTC conducting layer 16 interposed between the heater wire 12 and the sensor wire 14 to separate them from one another. Resistor Rntc is not a component of the heating element 10 per se but rather represents a distributed resistance property of the NTC layer 16.

The heating element 10 is placed in a circuit with a DC Source 24, an AC generator 18, or other source of alternating current, and a phase shift detector 20, along with switches SW1, SW2, SW3 and a capacitor 22 as shown in FIG. 1A. Instead of switches, it is foreseen that other electronic components as known in the art that enable selective control of the flow of electricity may be used.

The circuit has two operating modes. In a first, heating mode, switches SW1 and SW2, connected to the first and second ends of the heater wire 12, respectively, are closed, and switch SW3, interposed between the sensor wire 14 and the AC generator 18, is open. A DC power current from the DC source 24 (e.g., a battery) flows through the heater wire 12 increasing its temperature. The sensor wire is floating and polarization of the NTC layer 16 does not occur. Every few seconds, the heating mode is interrupted, e.g., by opening the switches SW1 and SW2, and the circuit is switched into a second, measurement or sensing mode.

During the measurement mode, switches SW1 and SW2 are open, and switch SW3 is closed. The AC generator 18, or another low power AC source, provides an excitation signal to measure the resistance of the NTC layer 16, designated R_{ntc}. The resistance R_{ntc} of the NTC layer 16 coupled with the capacitor 22 provides a phase shift proportional to the value of R_{ntc}. With an increase in temperature, the resistance R_{ntc} of the NTC layer 16 and the resulting phase shift decrease. The phase shift detector 20 compares the phase shift between PHASE 1 (direct output from the AC generator 18) and PHASE 2 (the AC signal on the capacitor 22) with a preset value. When the detected phase shift is smaller than the preset value, the next heating cycle is skipped to prevent overheating. More generally, the phase shift detector 20 compares a phase shift between an output signal direct from the AC generator 18 and an AC signal on the capacitor 22 relative to the pre-set value, whereby initiation of the heating mode is controlled based on the comparison of the phase shift relative to the pre-set value.

Since only AC current is passing through the NTC layer 16 in this mode, polarization of the NTC layer 16 does not occur.

The capacitor 22 may be substituted with an inductor or any other reactance. If an inductive component is used, the phase shift will occur in a direction opposite to that of the capacitive one, but the magnitude of the shift will still be proportional to the resistance of the NTC layer and indicative of the temperature of the heating element.

FIG. 1B illustrates an amplitude-based implementation of the AC excitation method, similar to that shown in FIG. 1A and the same reference numbers designate the same elements. However, instead of the phase shift detector 20 and capacitor 22, the circuit shown in FIG. 1B includes a voltage detector 26 and a load resistor R_{load} electrically coupled thereto.

The circuit shown in FIG. 1B also has two operating modes. In a first, heating mode, switches SW1 and SW2 are closed, and switch SW3 is open. A DC power current from the DC source 24 (e.g., a battery) flows through the heater wire 12 increasing its temperature. The sensor wire 14 is floating and polarization of the NTC layer 16 does not occur. Every few seconds, this mode is interrupted, e.g., by opening the switches SW1 and SW2, and the circuit is switched into a second, measurement or sensing mode.

During the measurement mode, switches SW1 and SW2 are open, and switch SW3 is closed. AC generator 18, or another low power AC source, provides an excitation signal to measure the resistance R_{ntc} of the NTC layer 16. The resistance R_{ntc} of the NTC layer 16 coupled with the load resistor R_{load} forms a voltage divider. The output voltage of this voltage divider is:

V_{ac2}=V_{ac1}*R_{load}/(R_{ntc}+R_{load})

wherein V_{ac1} is the known voltage at the output of AC generator 18, and

V_{ac2} is the voltage of the voltage divider.

To derive the value of R_{ntc}, this equation is transformed to:

R_{ntc}=(V_{ac1}/V_{ac2}−1)*R_{load}

With an increase in temperature, the resistance R_{ntc} of the NTC layer 16 decreases, and the output voltage of the voltage divider increases. A voltage detector 26 compares the output voltage V_{ac2} of the voltage divider with a preset value, and when the output voltage V_{ac2} is greater than the pre-set value, the next heating cycle is skipped. More generally, the voltage detector 26 compares an output voltage of the voltage divider with the pre-set value, with initiation of the heating mode being controlled based on the comparison of the output voltage of the voltage divider to the pre-set value.

If the output voltage of the AC generator 20 is subject to change, the ratio of voltages V_{ac1} and V_{ac2} provides a reliable measure of the temperature of the NTC layer 16.

Since only AC current is provided through the NTC layer 16 in this mode, polarization of the NTC layer 16 does not occur.

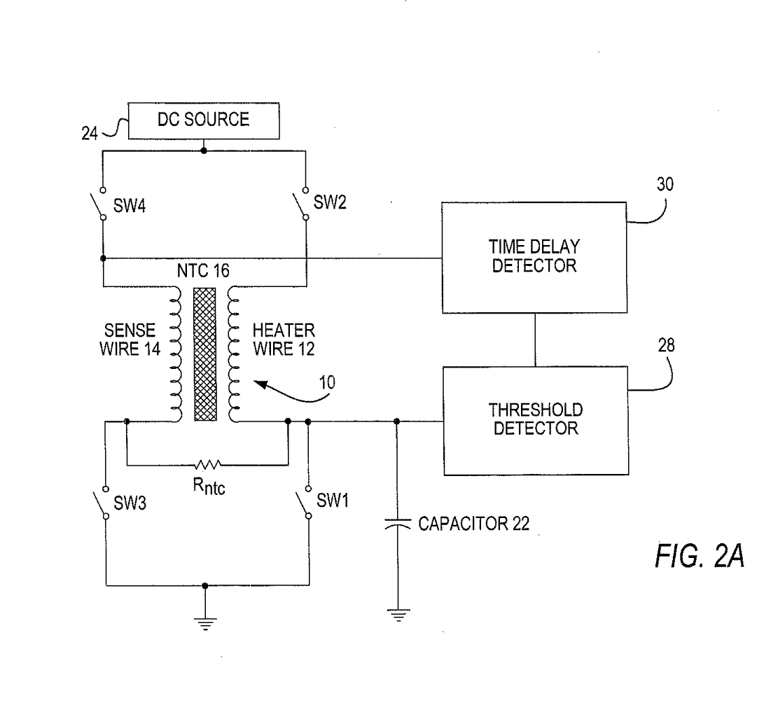

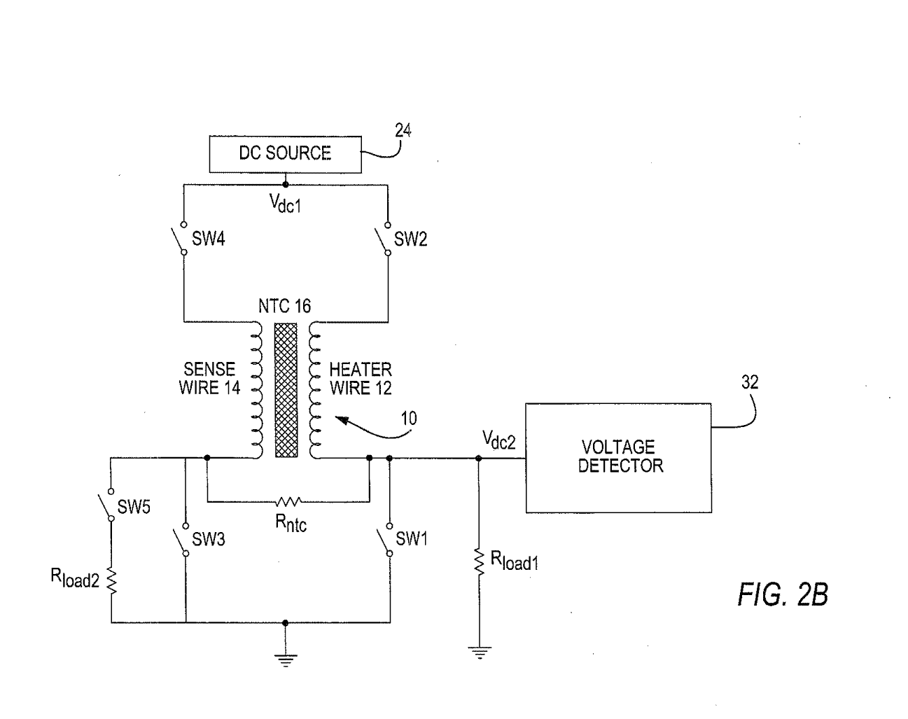

FIGS. 2A and 2B illustrate circuits wherein the temperature of a heater wire, forming part of a heating element that also includes an NTC layer, is controlled. In these systems and methods for using them, a circuit is constructed and controlled such that if some electric current is passed through the NTC layer at any period of time, an opposite direction compensation current is passed through the same NTC layer in the immediately following period of time, and is therefore referred to as an equal energy transfer method. The magnitude and duration of the compensation current is set to equalize the amount of energy transferred through the NTC layer in both directions.

The circuit shown in FIG. 2A has two operating modes. In a first, heating mode, switches SW1 and SW2 connected to the first and second ends of the heater wire 12, respectively, are closed, and switches SW3 and SW4, connected to the first and second ends of the sensor wire 12, respectively, are open. A DC power current from the DC source 24 (e.g., battery) flows through the heater wire 12 increasing its temperature. The sensor wire 14 is floating and polarization of the NTC layer 16 does not occur. Instead of switches, it is foreseen that other electronic components that enable selective control of the flow of electricity may be used.

Alternatively, in the heating mode, the switches SW3 and SW4 may be also closed. In this case, the sensor wire acts as a supplementary heater wire. Since the first and second ends of both the heater wire 12 and the sensor wire 14 are connected to the same positive and negative supply terminals, a voltage differential is not created in any place along the length of the heater wire 12.

Every few seconds, the heating mode is interrupted, and the circuit is switched into a second, measurement or sensing mode.

The measurement mode consists of at least two periods. During a first period of the measurement mode, switches SW1, SW2 and SW3 are open, and switch SW4 is closed. Current from the DC source 24 flows through the switch SW4 and the NTC layer 16 and charges capacitor 22, connected to the second end of the heater wire 12, long enough to ensure that capacitor 22 is charged to the supply voltage. At some point, the voltage at capacitor 22 reaches a threshold level preset in a threshold detector 28 connected to the second end of the heater wire 12. A time delay between a closure of the switch SW4 and a threshold crossing is generally proportional to the resistance R_{ntc} of the NTC layer 16. With an increase in temperature, the resistance R_{ntc} of the NTC layer 16 and the resulting time delay decrease. A time delay detector 30 compares the time delay with a preset value and if the detected time delay is smaller than the pre-set value, the next heating cycle is skipped. More generally, a time delay between closure of the switch SW4 and capacitor 22 reaching the threshold is determined via the time delay detector 30, and initiation of the heating mode of the heater wire 12 is controlled based on the detected time delay.

The second period of the measurement mode immediately follows the first one. During this period, switches SW1, SW2 and SW4 are open and switch SW3 is closed. Capacitor 22 discharges through the NTC layer 16 and the switch SW3 long enough to ensure that the capacitor 22 is fully discharged. In this manner, the amount of energy transferred through the NTC layer 16 during the first measurement period and during the second measurement period are equalized so that the average amount of energy transferred through the NTC layer 16 in the entire measurement mode equals zero. Polarization of the NTC layer 16 does not occur.

The duration of the measurement mode periods may be reduced by switching to the second period either immediately after the capacitor voltage reaches the threshold or at any time thereafter. Since the energy accumulated in the capacitor 22 during the charge time is the only energy available for the discharge, the amount of energy transferred through the NTC layer 16 in both directions will invariably be equal.

The measurement period cycles may be repeated several times to increase measurement accuracy.

FIG. 2B illustrates an amplitude-based implementation of the equal energy transfer method described with reference to FIG. 2A and includes similar components having the same functions described above. However, the circuit shown in FIG. 2B differs from that shown in FIG. 2A in that it includes a first load resistor R_{load1} electrically coupled between the second end of the heater wire 12 and ground, instead of capacitor 22, an additional switch SW5 and a second load resistor R_{load2} electrically coupled between the second end of the sensor wire 14 and ground, and a voltage detector 32, instead of the threshold detector 28 and time delay detector 30 of the embodiment shown in FIG. 2A.

The circuit shown in FIG. 2B also has two operating modes. In a first, heating mode, switches SW1 and SW2 are closed, and switches SW3, SW4 and SW5 are open. A DC power current from the DC source 24 (e.g., a battery) flows through the heater wire 12 increasing its temperature. The sensor wire 14 is floating and polarization of the NTC layer 16 does not occur.

Alternatively, in this mode the switches SW3 and SW4 may also be closed. In this case, the sensor wire 14 acts as a supplementary heater wire. Since the first and second ends of both the heater wire 12 and the sensor wire 14 are connected to the same positive and negative supply terminals, a voltage differential is not created in any place along the length of the heater wire 12.

Every few seconds, this mode is interrupted, and the circuit is switched into a second, measurement or sensing mode.

The measurement mode consists of at least two periods. During a first period of the measurement mode, switches SW1, SW2, SW3 and SW5 are open, and switch SW4 is closed. Current from the DC source 24 having a voltage of V_{dc1} flows through switch SW4 and the resistance R_{ntc} of the NTC layer 16, and develops a voltage drop V_{dc2} on the load resistor R_{load1}. The resistance R_{ntc} of the NTC layer 16 coupled with the load resistor R_{load1} forms a voltage divider. An equation representing the voltage drop is as follows:

V_{dc2}=V_{dc1}*R_{load1}/(R_{ntc}+R_{load1})

With an increase in temperature, the resistance R_{ntc} of the NTC layer 16 decreases, and the output voltage of the voltage divider increases. The voltage detector 32 compares the output voltage V_{dc2} of the voltage divider with a preset value and if the output voltage of the voltage divider is greater than the pre-set value, the next heating cycle is skipped. More generally, the voltage detector 32 compares an output voltage V_{dc2} of the voltage divider with a preset value, and initiation of the heating mode is controlled based on the comparison of the output voltage V_{dc2} of the voltage divider relative to the pre-set value.

The second period of the measurement mode immediately follows the first one. During this period, switches SW1, SW3 and SW4 are open and switches SW2 and SW5 are closed. Current from the DC source 24 flows through switch SW2 and the resistance R_{ntc} of the NTC layer 16 and develops a voltage drop across R_{load2}.

If R_{load1}=R_{load2}, the duration of both periods of the measurement mode are substantially equal. However, if R_{load1} is not equal to R_{load2}, then the duration of the second measurement mode period should satisfy the equation:

tₘₑₐₛ₂=(tₘₑₐₛ₁R_{load2}V₁)/(R_{load1}V₂)

Thus, the time during which the switches SW2 and SW5 are closed (tₘₑₐₛ₂) is controlled based on the load resistors R_{load1} and R_{load2}, corresponding voltage drops V₁ and V₂ on the load resistors and the time (tₘₑₐₛ₁) during which the switch SW4 is closed and the remaining switches are open (i.e., the time of the first measurement period). This control may be effected by common electronic components as known to those skilled in the art to which this invention pertains.

In this manner, the amount of energy transferred through the NTC layer 16 during the first period of the measurement mode and the second period of the measurement mode are equalized and the average amount of energy transferred through the NTC layer 16 in the entire measurement mode equals zero. As such, polarization of the NTC layer 16 does not occur.

The two periods of the measurement mode may be repeated several times, e.g., in cycles, to increase measurement accuracy.

It is recognized that other positions of the phase shift capacitor 22 and other positions of the load resistors R_{load1} and R_{load2} are possible, as well as the Rntc test current may be originated from the heater wire 12 side with the corresponding change in the detectors position and switches operation. All these changes do not constitute a departure from the scope and spirit of the present invention.

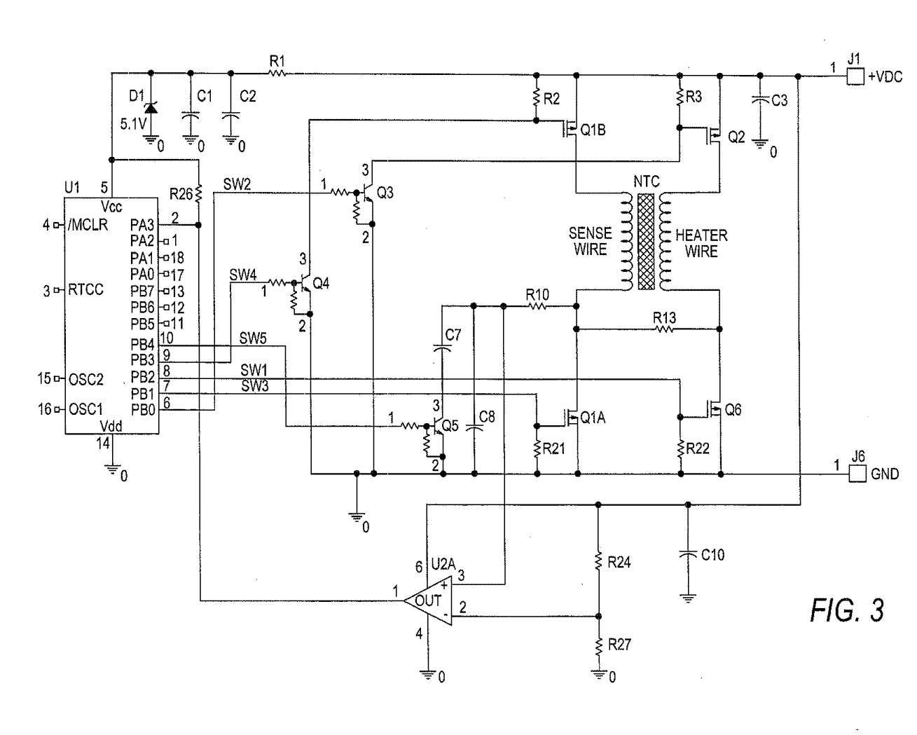

One of the practical implementations of the equal energy transfer technique described above with reference to FIG. 2A is in a battery-operated heating pad or electric blanket controller and is shown in FIG. 3.

In FIG. 3, a MOSFET Q6 represents switch SW1 shown in FIG. 2A, MOSFET Q2 represents switch SW2, MOSFET Q1A represents switch SW3, and MOSFET Q1B represents switch SW4. Capacitor C8 is equivalent to the capacitor 22 in FIG. 2A, in this case situated at the sensor wire side as was mentioned above. The threshold detector 28 is implemented as a generic voltage comparator U2A, and the threshold is set by a voltage divider R24R27 at exactly one half of the battery voltage. A generic microcontroller U1 controls the entire circuit operation and performs the time delay detector function, i.e., incorporates the time delay detector 30 shown in FIG. 2A.

Composite transistors Q3 and Q4 and resistors R2 and R3 perform a level shift function to control P-channel MOSFETs Q1B and Q2, corresponding to switches SW4 and SW2, respectively. Zener diode D1 along with resistor R1 and capacitors C1 and C2 comprise a microcontroller power supply, and the limit voltage is set at about 5V.

Another optional composite transistor Q5 connects an optional capacitor C7 in parallel to capacitor C8 to enhance time measurement resolution when measuring small resistances, as explained below.

The circuit shown in FIG. 3 is designed to be generally insensitive to the battery voltage and possible variations of the timing capacitor. It also provides the sensor wire resistance measurement, which is indicative of the integral temperature of the heating element 10.

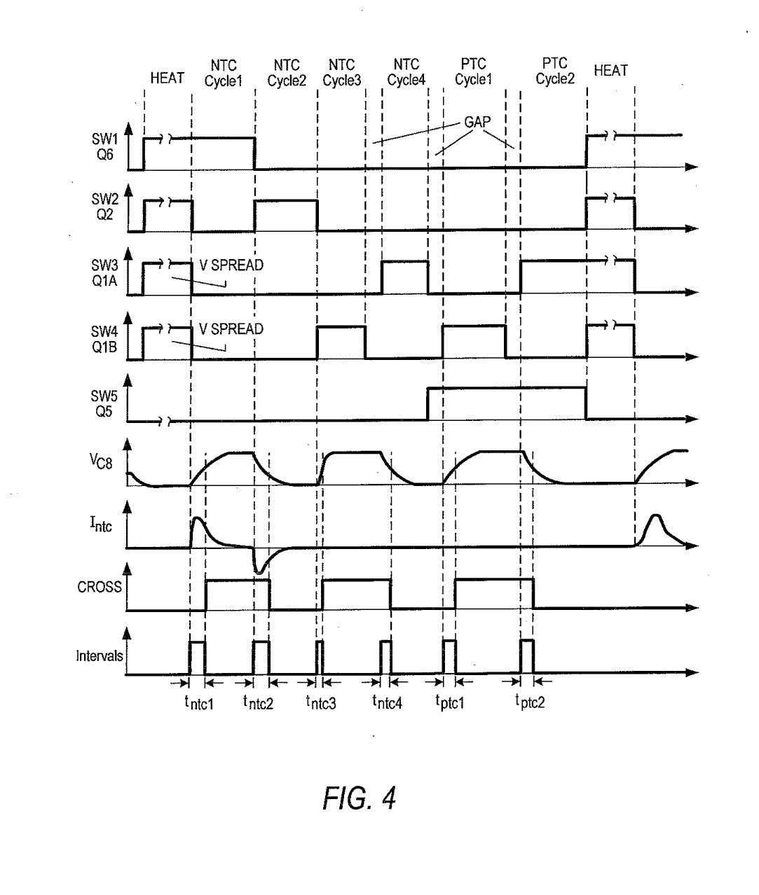

The principle of operation of the circuit shown in FIG. 3 is illustrated in FIG. 4. The Gap time intervals are added to compensate for physical delays associated with the MOSFETs switching On and Off.

The circuit operates as follows:

1. Heating Cycle. All four MOSFET switches (Q1A, Q1B, Q2 and Q6) are ON. The heater wire and the sensor wire provide heat. Capacitor C8 is held at 0V by conducting Q1A.

2. NTC Layer Resistance Measurement:

a. Cycle 1. Switch Q2 is On, all other switches are Off. Capacitor C8 charges through the NTC layer in parallel with resistor R13, and resistor R10. When the voltage at capacitor C8 reaches the threshold voltage, comparator U2A changes its output voltage from low to high. The time interval is stored by MCU U1 as t_{ntc1}. Capacitor C8 is allowed to charge to the full battery voltage.

b. Cycle 2. Switch Q6 is On, all other switches are Off. Capacitor C8 discharges through resistor R10 and the NTC layer in parallel with resistor R13. When the voltage at capacitor C8 reaches the threshold voltage, comparator U2A changes its output voltage from high to low. The time interval is stored by MCU U1 as t_{ntc2}. Capacitor C8 is allowed to fully discharge.

c. Cycle 3. Switch Q1B is On, all other switches are Off. Capacitor C8 charges through the sensor wire and resistor R10. When the voltage at capacitor C8 reaches the threshold voltage, comparator U2A changes its output voltage from low to high. The time interval is stored by MCU U1 as t_{ntc3}. Capacitor C8 is allowed to charge to the full battery voltage.

d. Cycle 4. Switch Q1A is On, all other switches are Off. Capacitor C8 discharges through resistor R10. When the voltage at capacitor C8 reaches the threshold voltage, comparator U2A changes its output voltage from high to low. The time interval is stored by MCU U1 as t_{ntc4}. Capacitor C8 is allowed to fully discharge.

3. PTC (Positive Temperature Coefficient) Sensor Wire Resistance Measurement:

a. Cycle 1. Switches Q1B and Q5 are On, all other switches are Off. Capacitors C8 and C7 charge through the sensor wire and resistor R10. When the voltage at capacitor C8 reaches the threshold voltage, comparator U2A changes its output voltage from low to high. The time interval is stored by MCU U1 as t_{ptc1}. Capacitors C8 and C7 are allowed to charge to the full battery voltage.

b. Cycle 2. Switches Q1A and Q5 are On, all other switches are Off. Capacitors C8 and C7 discharge through resistor R10. When the voltage at capacitor C8 reaches the threshold voltage, comparator U2A changes its output voltage from high to low. The time interval is stored by MCU U1 as t_{ptc2}. Capacitors C8 and C7 are allowed to fully discharge.

The optional capacitor C7 was added in parallel to capacitor C8 to increase the resistance measurement resolution, since the temperature coefficient of the sensor wire resistance is rather small.

4. Computation:
a. NTC layer resistance is calculated as

R_{NTC}=R10*[(t_{ntc1}+t_{ntc2})/2t_{ntc4}−1].

Since voltage or capacitance values are not in the equation, and R10 is a known fixed resistor, R_{NTC} is measured in a voltage and capacitor value variation-independent manner.
b. PTC Sensor wire resistance is calculated as

R_{PTC}=R10*(t_{ptc1}/t_{ptc2}−1).

Since voltage or capacitance values are not in the equation, and R10 is a known fixed resistor, R_{PTC} is measured in a voltage and capacitor variation-independent manner.

5. Decision making. The heater wire design provides that R_{NTC} and R_{PTC} values are representative of the immediate heater wire temperature. The corresponding preset values of these resistances are selected to keep the heater wire at the preset temperature. If R_{NTC} is smaller than (or equal to) a preset value, the next heating cycle is replaced by a time interval, when all switches are Off. Similarly, if R_{PTC} is greater than (or equal to) a preset value, the next heating cycle is replaced by a time interval, when all switches are Off. In this manner, the temperature of the heater wire is reliably controlled.

The I_{NTC} graph in FIG. 4 depicts the current passing through the NTC layer of the heating element. As can be seen, the NTC layer is exposed only to symmetrical bipolar pulses, which eliminate any harmful polarization or aging effects normally associated with a DC application of this type of NTC dielectric.

To increase resolution of resistance measurement and to enhance noise immunity, any pair of the charge/discharge cycles may be repeated several times and the appropriate time values added up.

In the circuit shown in FIG. 3, it is required that the threshold voltage of the voltage comparator is set at exactly one half of the battery voltage for the proposed equations to hold valid.

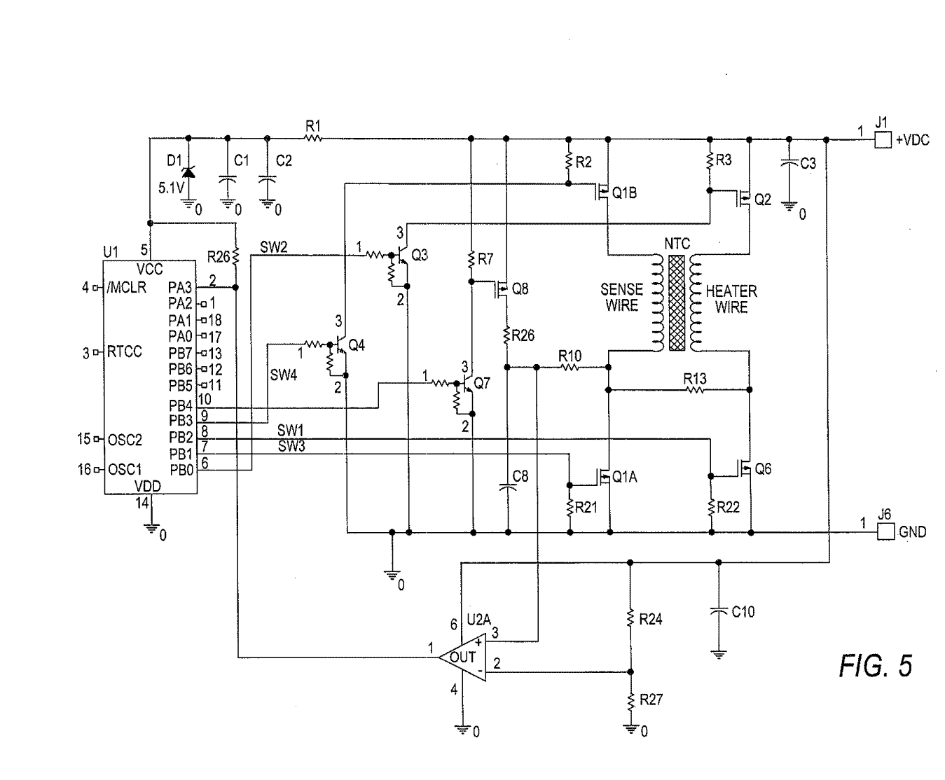

The circuit shown in FIG. 5 offers a more universal solution. Specifically, by adding another low cost switch Q8 with a corresponding level shifter Q7 and a resistor R28, the circuit shown in FIG. 5 offers more relaxed tolerance requirements of the components, and permits the use of an inexpensive operational amplifier (opamp) for voltage comparator U2A. The threshold voltage can be set at any practical level, e.g., taken from the MCU power supply. Resistor R10 in this case, is used to limit discharge current through switch Q1A, and may be omitted.

The circuit shown in FIG. 5 operates as follows:

1. Heating Cycle. Switches Q1A, Q1B, Q2 and Q6 switches are ON. Heater wire and the sensor wire provide heat. Capacitor C8 is held at 0V by conducting Q1A.

2. NTC layer resistance measurement:

a. Cycle 1. Switch Q2 is On, all other switches are Off. Capacitor C8 charges through the NTC layer in parallel with resistor R13, and resistor R10. When the voltage at capacitor C8 reaches the threshold voltage, comparator U2A changes its output voltage from low to high. The time interval is stored by MCU U1 as t_{ntc1}. Capacitor C8 is allowed to charge to the full battery voltage. (Alternatively, the charge may be stopped and the next cycle may be initiated at any time after the threshold is reached.)

b. Cycle 2. Switch Q6 is On, all other switches are Off. Capacitor C8 discharges through R10 and the NTC layer in parallel with resistor R13. When the voltage at capacitor C8 reaches the threshold voltage, comparator U2A changes its output voltage from high to low. Capacitor C8 is allowed to fully discharge.

3. PTC (Positive Temperature Coefficient) Sensor wire resistance measurement:

a. Cycle 1. Switch Q1B is On, all other switches are Off. Capacitor C8 charges through the sensor wire and resistor R10. When the voltage at capacitor C8 reaches the threshold voltage, comparator U2A changes its output voltage from low to high. The time interval is stored by MCU U1 as t_{ptc1}. Capacitor C8 is allowed to charge to the full battery voltage. Alternatively, the charge may be stopped and the next cycle may be initiated at any time after the threshold is reached.

b. Cycle 2. Switch Q1A is On, all other switches are Off. Capacitor C8 discharges through resistor R10. When the voltage at capacitor C8 reaches the threshold voltage, comparator U2A changes its output voltage from high to low. Capacitor C8 is allowed to fully discharge.

4. Reference Resistance Measurement:

a. Cycle 1. Switch Q8 is On, all other switches are Off. Capacitor C8 charges through resistor R28. When the voltage at capacitor C8 reaches the threshold voltage, comparator U2A changes its output voltage from low to high. The time interval is stored by MCU U1 as t_{ref}. (The charge may be stopped and the next cycle may be initiated at any time after the threshold is reached.)

b. Cycle 2. Switch Q1A is On, all other switches are Off. Capacitor C8 discharges through resistor R10. When the voltage at capacitor C8 reaches the threshold voltage, comparator U2A changes its output voltage from high to low. Capacitor C8 is allowed to fully discharge.

5. Computation:
a. NTC layer resistance is calculated as

R_{NTC}=R28*t_{ntc1}/t_{ref}−R10,
or if R10=0,

R_{NTC}=R28*t_{ntc1}/t_{ref}

Since voltage or capacitance values are not in the equation, and R28 and R10 are known fixed value resistors, R_{NTC} is measured in a voltage and capacitor value variation-independent manner.
b. PTC Sensor wire resistance is calculated as

R_{PTC}=R28*t_{ptc1}/t_{ref}−R10,
or if R10=0,

R_{PTC}=R28*t_{ptc1}/t_{ref}

Since voltage or capacitance values are not in the equation, and R28 and R10 are known fixed resistors, R_{PTC} is measured in a voltage and capacitor value variation-independent manner.

6. Decision making. The heater wire design provides that R_{NTC} and R_{PTC} values are representative of the immediate temperature of the heater wire. The corresponding preset values of these resistances are selected to keep the heater wire at the preset temperature. If R_{NTC} is smaller than (or equal to) a preset value, the next heating cycle is replaced by a time interval, when all switches are Off. Similarly, if R_{PTC} is greater than (or equal to) a preset value, the next heating cycle is replaced by a time interval, when all switches are Off. In this manner, the temperature of the heater wire is reliably controlled.

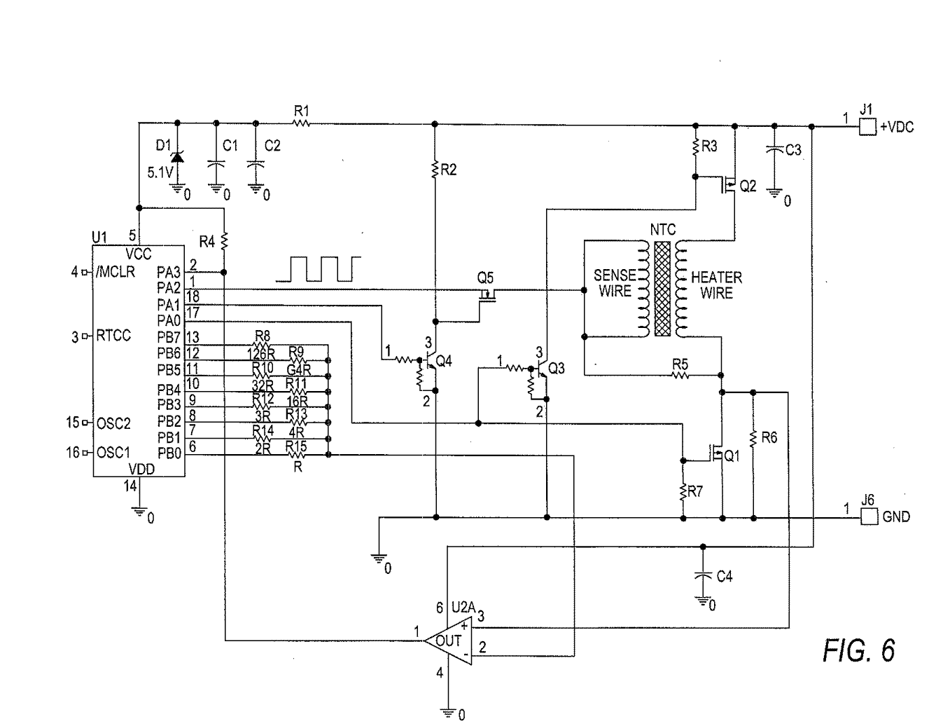

One of the possible implementations of the AC excitation method of FIG. 1B is shown in FIG. 6. This implementation uses an amplitude-based measurement configuration. In FIG. 6, the switch SW1 is implemented as a MOSFET Q1, the switch SW2 is implemented as MOSFET Q2, and the switch SW3 is implemented as MOSFET Q5. MOSFETs Q3 and Q4 perform a level shifting function. A generic microcontroller U1 functions as the AC generator 18 by providing a 50% duty cycle square wave on one of its pins. Together with the voltage comparator U2, the microcontroller U1 and resistors R8-R15 provide a voltage detection (measurement) function, i.e., comprise the voltage detector 26. The microcontroller U1 and the resistors R8-R15 form a digital to analog converter. Resistor R1, diode D1 and capacitors C1 and C2 form a microcontroller power supply.

The circuit operates as follows:

1. Heating Cycle. Switches Q1 and Q2 are ON, switch Q5 is Off. The heater wire provides heat. Switch Q5 blocks any current through the NTC layer. Every few seconds, the heating cycle is interrupted by the NTC layer resistance measurement procedure.

2. NTC layer resistance measurement: Switches Q1 and Q2 are Off, Switch Q5 is On. Microcontroller U1 provides a 50% duty cycle square wave on Pint (PA2). This square wave passes through the switch Q5 to a voltage divider formed by the resistance of the NTC layer in parallel with resistor R5, and a load resistor R6. During the high portion of the square wave, the microcontroller U1 creates a linear voltage ramp rising from 0V to the Vcc voltage of the microcontroller by incrementing a binary 8 bit word at the PB0-PB7 ports. This voltage ramp is compared by the voltage comparator U2A with voltage on the load resistor R6. When the ramp voltage exceeds the voltage on R6, the value of the binary word at PB0-PB7 is stored by the microcontroller as Nntc.

3. Computation: NTC layer resistance is calculated as

R_{ntc}=(256/Nntc−1)*R6

Since the AC excitation voltage and the reference voltage of the digital to analog converter are derived from the same source, the microcontroller's Vcc voltage, these values do not affect the calculation results. The entire computation stage may be omitted for the fixed value of the load resistor R6. In this case, the Nntc value should be used for decision making.

4. Decision making. The heating element design provides that R_{NTC} is representative of the immediate heater wire temperature. The corresponding preset values of these resistances are selected to keep the heater wire at the preset temperature. If R_{NTC} is smaller than (or equal to) a preset value, the next heating cycle is replaced by a time interval, when all switches are Off.

Alternatively, if the calculation step has been omitted, the Nntc value can be used as the heater device temperature measure. This value should be compared to a preset number or value. If N_{NTC} is greater than (or equal to) the preset number, the next heating cycle is replaced by a time interval, when all switches are Off. In this manner, the temperature of the heater device is reliably controlled.

The above described implementations demonstrate basic On/Off control algorithms, and are not intended to limit the application of the circuits in accordance with the invention. By changing the duration of the heating cycle period and/or the Off period, any type of more sophisticated control algorithms may be implemented.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A method for controlling heating of a heater conductor of a heating element including a sensor conductor and a negative temperature coefficient (NTC) layer interposed between the heater conductor and the sensor conductor and separating them from one another, the method comprising:
heating the heater conductor in a heating mode by causing DC power current from a direct current (DC) source to flow through the heater conductor and increase its temperature;
periodically terminating the heating mode and entering into a measurement mode in which an alternating current (AC) source provides an excitation signal to enable measurement of resistance of the NTC layer; and
controlling initiation of the heating mode based on the measurement of the resistance of the NTC layer in the measurement mode.

2. The method of claim 1, wherein the step of heating the heater conductor comprises:
interposing a first switch between a first end of the heater conductor and the DC source;
interposing a second switch between a second end of the heater conductor and ground; and
closing both switches.

3. The method of claim 1, wherein the DC source is connected to a first end of the heater device, further comprising:
arranging a reactive element relative to the NTC layer and the AC source such that the reactive element is charged and discharged through the NTC layer;
coupling a first input of a phase shift detector to the AC source and a second input of the phase shift detector to said reactive element; and
comparing a phase shift between an output signal from the AC source and an AC signal on the reactive element relative to a preset value, initiation of the heating mode being controlled based on the comparison of the phase shift relative to the pre-set value.

4. The method of claim 3, wherein with rising temperature of the heater conductor, the resistance of the NTC layer and the resulting phase shift decrease such that when the detected phase shift is smaller than the preset value, a further heating of the heater conductor is temporarily suspended.

5. The method of claim 3, further comprising selecting the reactive element to be one of a capacitive element and an inductive element.

6. The method of claim 1, wherein the DC source is connected to a first end of the heater conductor, further comprising:
arranging a resistive element relative to the NTC layer and the AC source such that the resistive element forms a voltage divider with resistance of said NTC layer; and
comparing, using a voltage detector, an output voltage of the voltage divider with a preset value, initiation of the heating mode being controlled based on the comparison of the output voltage of the voltage divider relative to the pre-set value.

7. The method of claim 1, wherein the DC source is connected to a first end of the heater conductor, further comprising:
arranging a resistive element relative to the NTC layer and the AC source such that the resistive element forms a voltage divider with resistance of said NTC layer; and
comparing, using a voltage detector, a ratio of an output voltage of the voltage divider and the AC source voltage with a preset value, initiation of the heating mode being controlled based on the comparison of said ratio with the pre-set value.

8. The method of claim 5, wherein with an increase in temperature of the heater conductor, the resistance of the NTC layer decreases and the output voltage of the voltage divider increases, and when the voltage detector determines that the output voltage of the voltage divider is greater than the pre-set value, a further heating of the heater conductor is temporarily suspended.

9. The method of claim 1, further comprising:
interposing a first switch between a first end of the heater conductor and the DC source;
interposing a second switch between a second end of the heater conductor and ground; and
interposing a third switch between the sensor conductor and the AC source.

10. The method of claim 1, further comprising:
interposing a first switch between a first end of the sensor conductor and the DC source;
interposing a second switch between a second end of the sensor conductor and ground; and
interposing a third switch between the heater conductor and the AC source.

11. A system for controlling heating of a heater conductor of a heating element including a sensor conductor and a negative temperature coefficient (NTC) layer interposed between the heater conductor and the sensor conductor and separating them from one another, the system comprising:
a direct current (DC) source;
a first switch operatively coupled between said DC source and a first end of said heater conductor;
a second switch operatively coupled between a second end of said heater conductor and ground;
an alternating current (AC) generator;
a third switch operatively coupled between said AC generator and said sensor conductor; and
a controller that controls heating of the heater conductor in a heating mode by closing said first and second switch while said third switch is open thereby causing DC power current from said DC source to flow through the heater conductor and increase its temperature,
said controller being further arranged to periodically terminate the heating mode and enter the system into a measurement mode in which said AC generator provides an excitation signal to enable measurement of resistance of said NTC layer by opening said first and second switches and closing said third switch,
said controller being further arranged to control initiation of the heating mode based on the measurement of the resistance of the NTC layer in the measurement mode.

12. The system of claim 11, further comprising:
a reactive element arranged relative to the NTC layer and the AC source such that the reactive element is charged and discharged through the NTC layer;
a phase shift detector having a first input operatively coupled to the AC source and a second input operatively coupled to said reactive element; and
a comparator which compares a phase shift between an output signal from the AC source and an AC signal on the reactive element relative to a preset value, wherein initiation of the heating mode being controlled based on the comparison of the phase shift relative to the pre-set value.

13. The system of claim 12, wherein with rising temperature of the heater conductor, the resistance of the NTC layer and the resulting phase shift decrease such that when the detected phase shift is smaller than the pre-set value, said controller is arranged to temporarily suspend a further heater of the heating conductor.

14. The system of claim 12, wherein said reactive element is operatively coupled between said second end of said heater conductor and ground.

15. The system of claim 12, wherein said reactive element is operatively coupled between a second end of said sensor conductor and ground.

16. The system of claim 11, further comprising:
a resistive element operatively arranged relative to the NTC layer and the AC source such that the resistive element forms a voltage divider with resistance of said NTC layer; and
a voltage detector operatively coupled to the heater conductor and a voltage divider, the voltage detector comparing an output voltage of the voltage divider with a preset value, wherein initiation of the heating mode being controlled based on the comparison of the output voltage of the voltage divider relative to the pre-set value.

17. The system of claim 11, further comprising:
a resistive element operatively arranged relative to the NTC layer and the AC source such that the resistive element forms a voltage divider with resistance of said NTC layer; and
a voltage detector operatively coupled to the voltage divider and the AC source, the voltage detector comparing a ratio of an output voltage of the voltage divider and the AC source voltage with a preset value, wherein initiation of the heating mode being controlled based on the comparison of said ratio with the pre-set value.

18. The system of claim 16, wherein with an increase in temperature of the heater device, the resistance of the NTC layer decreases and the output voltage of the voltage divider increases, and when said voltage detector determines that the output voltage of the voltage divider is greater than the pre-set value, said controller is arranged to temporarily suspend further heating of the heater conductor.

19. A system for controlling heating of a heater conductor of a heating element including a sensor conductor and a negative temperature coefficient (NTC) layer interposed between the heater conductor and the sensor conductor and separating them from one another, the system comprising:
a direct current (DC) source;
a first switch operatively coupled between said DC source and a first end of said sensor conductor;
a second switch operatively coupled between a second end of said sensor conductor and ground;
an alternating current (AC) generator;
a third switch operatively coupled between said AC generator and said heater conductor; and
a controller that controls heating of the heater conductor in a heating mode by closing said first and second switch while said third switch is open thereby causing DC power current from said DC source to flow through the heater conductor and increase its temperature,
said controller being further arranged to periodically terminate the heating mode and enter the system into a measurement mode in which said AC generator provides an excitation signal to enable measurement of resistance of said NTC layer by opening said first and second switches and closing said third switch,
said controller being further arranged to control initiation of the heating mode based on the measurement of the resistance of the NTC layer in the measurement mode.

20. The system of claim 19, further comprising:
a reactive element arranged relative to the NTC layer and the AC source such that the reactive element is charged and discharged through the NTC layer;
a phase shift detector having a first input operatively coupled to the AC source and a second input operatively coupled to said reactive element; and
a comparator which compares a phase shift between an output signal from the AC source and an AC signal on the reactive element relative to a preset value, wherein initiation of the heating mode being controlled based on the comparison of the phase shift relative to the pre-set value.

21. The system of claim 20, wherein with rising temperature of the heater conductor, the resistance of the NTC layer and the resulting phase shift decrease such that when the detected phase shift is smaller than the pre-set value, said controller is arranged to temporarily suspend a further heating of the heating conductor.

22. The system of claim 20, wherein said reactive element is operatively coupled between said second end of said sensor conductor and ground.

23. The system of claim 20, wherein said reactive element is one of a capacitive element and an inductive element.

24. The system of claim 19, further comprising:
a resistive element operatively arranged relative to the NTC layer and the AC source such that the resistive element forms a voltage divider with resistance of said NTC layer; and
a voltage detector operatively coupled to the sensor conductor and a voltage divider, the voltage detector comparing an output voltage of the voltage divider with a preset value, wherein initiation of the heating mode being controlled based on the comparison of the output voltage of the voltage divider relative to the pre-set value.

25. The system of claim 19, further comprising:
a resistive element operatively arranged relative to the NTC layer and the AC source such that the resistive element forms a voltage divider with resistance of said NTC layer; and
a voltage detector operatively coupled to the voltage divider and the AC source, the voltage detector comparing a ratio of an output voltage of the voltage divider and the AC source voltage with a preset value, wherein initiation of the heating mode being controlled based on the comparison of said ratio with the pre-set value.

26. The system of claim 24, wherein with an increase in temperature of the heater device, the resistance of the NTC layer decreases and the output voltage of the voltage divider increases, and when said voltage detector determines that the output voltage of the voltage divider is greater than the pre-set value, said controller is arranged to temporarily suspend further heating of the heating conductor.

27. A method for controlling heating of a heater conductor of a heating element including a sensor conductor and a negative temperature coefficient (NTC) layer interposed between the heater device and the sensor conductor to separate them from one another, the method comprising:
heating the heater conductor in a heating mode by causing DC power current from a direct current (DC) source to flow through the heater conductor and increase its temperature;
periodically terminating the heating mode and entering into a measurement mode in which:
in a first period, closing a switch to cause DC current from the DC source to flow through the NTC layer and charge a capacitor, detecting when the voltage of the capacitor reaches a threshold via a threshold detector, and determining a time delay between closure of the switch and the capacitor reaching the threshold via a time delay detector, and
in a second period following the first period, causing the capacitor to discharge through the NTC layer such that an amount of energy transferred through the NTC layer during the first and second periods is equal; and
controlling initiation of the heating mode via a controller based on the time delay.

28. The method of claim 27, wherein the step of heating the heater conductor comprises:
interposing a first switch between a first end of the heater conductor and the DC source;
interposing a second switch between a second end of the heater conductor and ground; and
closing both switches.

29. The method of claim 27, further comprising heating the sensor conductor during the heating mode by causing DC current from the DC source to flow through the sensor conductor and increase its temperature such that the sensor device acts as a supplementary heater conductor.

30. The method of claim 29, wherein the step of heating the sensor conductor comprises:
interposing a first switch between a first end of the sensor conductor and the DC source;
interposing a second switch between a second end of the sensor conductor and ground; and
closing both switches.

31. The method of claim 27, wherein the time delay is proportional to a resistance of the NTC layer and as the heater conductor increases in temperature, the resistance of the NTC layer and the resulting time delay decrease such that the time delay detector compares the time delay with a preset value and when the detected time delay is smaller than the pre-set value, a further heating of the heater conductor is temporarily suspended.

32. A system for controlling heating of a heater conductor of a heating element including a sensor conductor and a negative temperature coefficient (NTC) layer interposed between the heater conductor and the sensor conductor to separate them from one another, the system comprising:
a direct current (DC) source;
a first switch operatively coupled between said DC source and a first end of said heater conductor;
a second switch operatively coupled between a second end of said heater conductor and ground;
a third switch operatively coupled between said DC source and a first end of said sensor conductor;
a fourth switch operatively coupled between a second end of said sensor conductor and ground;
a capacitive element arranged relative to said NTC layer to be charged and discharged through said NTC layer;
a controller that controls heating of the heater conductor in a heating mode by closing said first and second switches thereby causing DC power current from said DC source to flow through said heater conductor and increase its temperature, said controller being arranged to periodically terminate the heating mode and enter the system into a measurement mode in which in a first period, said third switch is closed and said first, second and fourth switches are open causing DC power current from said DC source to flow through said NTC layer and charge said capacitive element;
a threshold detector that detects when the voltage of said capacitive element reaches a threshold; and
a time delay detector that determines a time delay between closure of said third switch and said capacitive element reaching the threshold, and
said controller being further arranged to enter the system into a second period of the measurement mode following the first period in which said fourth switch is closed and said first, second and third switches are open to cause said capacitive element to discharge through said NTC layer until said capacitive element is fully discharged, whereby an amount of energy transferred through said NTC layer during the first and second periods is equal,
said controller being further arranged to control initiation of the heating mode based on the time delay detected by said time delay detector.

33. The system of claim 32, wherein said capacitive element is operatively coupled between said second end of said heater conductor and ground.

34. The system of claim 32, wherein said capacitive element is operatively coupled between said second end of said sensor conductor and ground.

35. The system of claim 32, wherein said controller is further arranged to close said third and fourth switches in the heating mode to thereby cause DC power current from said DC source to flow through the sensor conductor and increase its temperature such that the sensor conductor acts as a supplementary heater conductor.

36. The system of claim 32, wherein the time delay is proportional to a resistance of said NTC layer and as said heater conductor increases in temperature, the resistance of said NTC layer and the resulting time delay decrease such that said time delay detector compares the time delay with a preset value and when the detected time delay is smaller than the pre-set value, said controller is arranged to temporarily suspend further heating of the heating conductor.

37. A method for controlling heating of a heater conductor of a heating element including a sensor conductor and a negative temperature coefficient (NTC) layer interposed between the heater conductor and the sensor conductor to separate them from one another, the method comprising:
heating the heater conductor in a heating mode by causing DC power current from a direct current (DC) source to flow through the heater conductor and increase its temperature;
periodically terminating the heating mode and entering into a measurement mode in which:
in a first measurement period,
causing DC power current from the DC source to flow through the NTC layer in a first direction, and
in a second measurement period following the first measurement period,
causing DC power current from the DC source to flow through the NTC layer in a second direction opposite to the first direction, and
controlling time of the flow of DC power current through the NTC layer in the second direction to provide that energy transferred through the NTC layer in the second measurement period is substantially equal to energy transferred through the NTC layer in the first measurement period; and
controlling initiation of the heating mode via a controller based on the magnitude of the DC current passed through the NTC layer in at least one of the first and second measurement periods.

38. The method of claim 37, wherein the step of causing DC power current from the DC source to flow through the NTC layer in the first direction during the first measurement period comprises developing a voltage drop on a first load resistor, resistance of the NTC layer coupled with the first load resistor forming a voltage divider, the first measurement period further comprising:
comparing, using a voltage detector, an output voltage of the voltage divider with a preset value,
initiation of the heating mode being controlled via the controller based on the comparison of the output voltage of the voltage divider relative to the pre-set value.

39. The method of claim 37, wherein the step of causing DC power current from the DC source to flow through the NTC layer in the first direction during the first measurement period comprises developing a voltage drop on a first load resistor, resistance of the NTC layer coupled with the first load resistor forming a voltage divider, the first measurement period further comprising:
comparing, using a voltage detector, a ratio of an output voltage of the voltage divider and the AC source voltage with a preset value, wherein initiation of the heating mode being controlled via the controller based on the comparison of said ratio with the pre-set value.

40. The method of claim 37, wherein the step of causing DC power current from the DC source to flow through the NTC layer in the second direction during the second measurement period comprises developing a voltage drop on a second load resistor, the step of controlling time of the flow of DC power current through the NTC layer in the second direction comprising controlling the time of the flow of DC power current through the NTC layer based on the voltage drops on the first and second load resistors, resistance of the first and second load resistors and a time of the first measurement period.

41. The method of claim 38, wherein with an increase in temperature of the heater conductor, the resistance of the NTC layer decreases and the output voltage of the voltage divider increases, and when the voltage detector determines that the output voltage of the voltage divider is greater than the pre-set value, a further heating of the heater conductor is temporarily suspended.

42. The method of claim 37, wherein the step of heating the heater conductor comprises:
interposing a first switch between a first end of the heater conductor and the DC source;
interposing a second switch between a second end of the heater conductor and ground; and
closing both switches.

43. The method of claim 37, further comprising heating the sensor conductor during the heating mode by causing DC power current from the DC source to flow through the sensor conductor and increase its temperature such that the sensor conductor acts as a supplementary heater conductor.

44. The method of claim 37, wherein the step of heating the sensor conductor comprises:
interposing a first switch between a first end of the sensor conductor and the DC source;
interposing a second switch between a second end of the sensor conductor and ground; and
closing both switches.

45. The method of claim 37, wherein the step of controlling time of the flow of DC power current through the NTC layer in the second direction during the second measurement period comprises controlling the time based on a time in which DC current flowed through the NTC layer in the first measurement period, and amplitudes of the current through the NTC layer in the first and second measurement periods such that a product of the amplitude and time for the first measurement period equals the product of the amplitude and time for the second measurement period.

46. A system for controlling heating of a heater conductor of a heating element including a sensor conductor and a negative temperature coefficient (NTC) layer interposed between the heater conductor and the sensor conductor to separate them from one another, the system comprising:
a direct current (DC) source;
a first switch operatively coupled between said DC source and a first end of said heater conductor;
a second switch operatively coupled between a second end of said heater conductor and ground;
a third switch operatively coupled between said DC source and a first end of said sensor conductor;
a fourth switch operatively coupled between a second end of said sensor conductor and ground; and
a controller that controls heating of the heater conductor in a heating mode by controlling said switches to cause DC power current from said DC source to flow through said heater conductor and increase its temperature, said controller being arranged to periodically terminate the heating mode and enter the system into a measurement mode in which in a first period, said switches are controlled to cause DC power current from said DC source to flow through said NTC layer in a first direction,
said controller being further arranged to, in a second measurement period following the first measurement period, control said switches to cause DC power current from said DC source to flow through said NTC layer in a second direction,
said controller being further arranged to control a time of the flow of DC power current through said NTC layer in the second direction to provide that energy transferred through said NTC layer in the second measurement period is substantially equal to energy transferred through said NTC layer in the first measurement period and to control initiation of the heating mode based on the energy being transferred through said NTC layer in at least one of the first and second measurement periods.

47. The system of claim 46, further comprising:
a first load resistor;
a second load resistor, said controller being arranged to enter the system into the first period of the measurement mode wherein the DC power current from said DC source flowing through said NTC layer causes a voltage drop to develop on said first load resistor, resistance of the NTC layer coupled with said first load resistor forming a voltage divider, said controller being further arranged to enter the system into the second period of the measurement mode wherein the DC power current from said DC source flowing through said NTC layer develops a voltage drop on said second load resistor; and
a voltage detector arranged to compare an output voltage of said voltage divider with a preset value;
said controller being further arranged to control a time of the flow of DC power current through said NTC layer device based on the voltage drops on said first and second load resistors, resistance of the first and second load resistors and a time of the first measurement period, and to control initiation of the heating mode based on the comparison of the output voltage of the voltage divider relative to the pre-set value.

48. The system of claim 47, wherein said first load resistor is operatively coupled between said second end of said heater conductor and ground, said second load resistor is operatively coupled between said second end of said sensor conductor and ground, further comprising a fifth switch operatively coupled between said second end of said sensor conductor and said second load resistor and which is controlled by said controller.

49. The system of claim 47, wherein with an increase in temperature of said heater conductor, the resistance of said NTC layer decreases and the output voltage of the voltage divider increases, and when said voltage detector determines that the output voltage of the voltage divider is greater than a preset value, said controller is arranged to temporarily suspended further heating of the heater conductor.

50. The system of claim 46, wherein said controller is further arranged to close said first, second, third and fourth switches in the heating mode to thereby cause DC power current from said DC source to flow through the sensor conductor and the heater conductor and increase the temperature of the sensor conductor such that the sensor conductor acts as a supplementary heater device.

51. The system of claim 46, wherein said controller controls the time of the flow of DC power current through said NTC layer in the second direction during the second measurement period based on a time in which DC current flowed through said NTC layer in the first measurement period, and amplitudes of the current through said NTC layer in the first and second measurement periods such that a product of the amplitude and time for the first measurement period equals the product of the amplitude and time for the second measurement period.
